(19) United States
(12) Patent Application Publication
(10) Pub. No.: US 2002/0196594 A1
(43) Pub. Date: Dec. 26, 2002

(54) Integrated circuit over voltage protection

(76) Inventors: Stephan Alan Cohen, Wappingers Falls, NY (US); John Anthony Fitzsimmons, Poughkeepsie, NY (US); Stephen McConnell Gates, Ossining, NY (US); Alfred Grill, White Plains, NY (US)

Correspondence Address: ALVIN JOSEPH RIDDLES, CANDLEWOOD ISLE, BOX 34, NEW FAIRFIELD, CT, 06812, US

(21) Appl. No.: 09/886,437

(22) Filed: Jun. 21, 2001

(51) Int. Cl. H02H 3/20

(52) U.S. Cl. 361/91.1

(57) ABSTRACT

An over voltage spike or surge protection principle is provided that involves an element that is positioned between a node in the circuitry and a reference voltage that performs as an insulator as voltage across the element increases and at a selectable voltage, the current at any higher voltage such as during a spike or a surge is shunted to reference or ground, the element is not damaged by the breakdown type of the effect of the shunting of the current, and then, after the duration of the high voltage excursion the element returns to the performance before the selectable voltage. The principle of the invention permits in-situ or locallized over voltage protection to selected nodes throughout circuitry as well as throughout an integrated circuit including the interface with external circuitry.

### FIELD OF THE INVENTION

The invention is in the field of the handling of over voltage occurrences such as spikes and surges that exceed the tolerable and desired conditions in integrated circuits and in particular to in situ over voltage protection, located in the chip and the associated external wiring.

### BACKGROUND AND RELATION TO THE PRIOR ART

As progress in integrated circuit technology systems take place, in which, as line to line and inter device spacing becomes smaller, the operating voltages in the systems, over the smaller physical distances produce higher and higher electric fields. Voltage variation occurrences in such electric fields can create damage in the wiring, interconnections and devices.

The general technology heretofore in the art has involved such approaches as using fusible links which must be replaced after each surge event or to build in voltage regulation, in the form of separate chips or protection circuitry in integrated circuit chips or mounted on the chip package; however, such an approach may operate to add parts or introduce additional process steps into the fabrication.

In a portion of a text titled “Circuit Design For Electronic Instrumentation” by Darold Wobschall, published by McGraw-Hill, 1979, pages 14, 360 and 361; some of the standard circuitry and methods in general use in the art are described. In general the art uses capacitors, devices and diodes that have performance characteristics that effectively shunt any voltage spikes or surges to reference potential or ground. Among the types of voltage regulation techniques, the voltage regulator diode type is extensively used. The voltage regulator diode devices are generally known in the art as Zener or Avalanche devices where the performance is such that, at a reverse biased breakdown voltage, the diode shunts off any voltage excursion above the breakdown voltage. In devices of this type the breakdown mechanism may require voltages considerably greater than voltage tolerances in high density integrated circuitry and further when voltages produce fields in the range above 7.2 million volts per centimeter (Mv/cm) the device becomes permanently conductive. Furthermore structural and process changes at the sizes to which the art is approaching will be very difficult. There is a need in the integrated circuitry voltage surge control art for simpler and more reliable arrangements because at the present state of the art the currently practiced arrangements do not handle all spike and surge problems, still take up valuable chip area and add to processing complexity.

### SUMMARY OF THE INVENTION

An over voltage spike or surge protection principle is provided that involves an element that is positioned between a node in the circuitry and a reference voltage that performs as an insulator as a field resulting from voltage across the element increases in a range below a selectable threshold voltage and at that selectable voltage, the current at any higher voltage such as during a spike or a surge is shunted to reference or ground, the element is not damaged by the breakdown type of the effect of the shunting of the current, and then, after the duration of the high voltage excursion the element returns to the performance before the over voltage occurrence. The principle of the invention permits in-situ or localized over voltage protection to selected nodes throughout circuitry as well as throughout an integrated circuit including the interface with external circuitry. The invention is not damaged by the occurrence of an over voltage event and thus may be used repeatedly for such protection.

### BRIEF DESCRIPTION OF THE DRAWINGS

FIG. 1 is a schematic cross sectional view of the over voltage protection element of the invention.

FIG. 2 is a graph depicting the current versus field performance characteristic curve of the non destructive breakdown type over voltage control element of the invention.

FIG. 3 is a schematic depiction illustrating the over voltage protection element of the invention at a chip to wiring interface of a typical integrated circuit structure.

FIG. 4 is a schematic depiction of the over voltage protection element of the invention applied to the control electrode of a three terminal device such as the gate of an FET transistor.

FIG. 5 is a schematic depiction of the over voltage protection element of the invention applied to an electrode such as the drain electrode of a field effect transistor.

### DESCRIPTION OF THE INVENTION

An over voltage spike or surge protection principle is provided through the invention where an element of a non destructive breakdown dielectric is positioned between a circuitry node and the circuitry reference voltage usually ground; the element performs as a dielectric or insulator at fields in a range below a selected field, about2 Mv/cm for example, resulting from voltage across the element increases, leveling at a selectable voltage related to the thickness dimension of the element and thereafter passing all current driven by any higher voltage, such as would occur with a surge or spike, is shunted to reference or ground. The over voltage protection element also exhibits the properties that; following the duration of the surge or spike high voltage excursion, the element does not become permanently conductive, returns to dielectric or insulator type performance, and is thus suitable for repeated use. The element of this invention may have a higher or lower “turn on field” than the 2 Mv/cm example, according to the design.

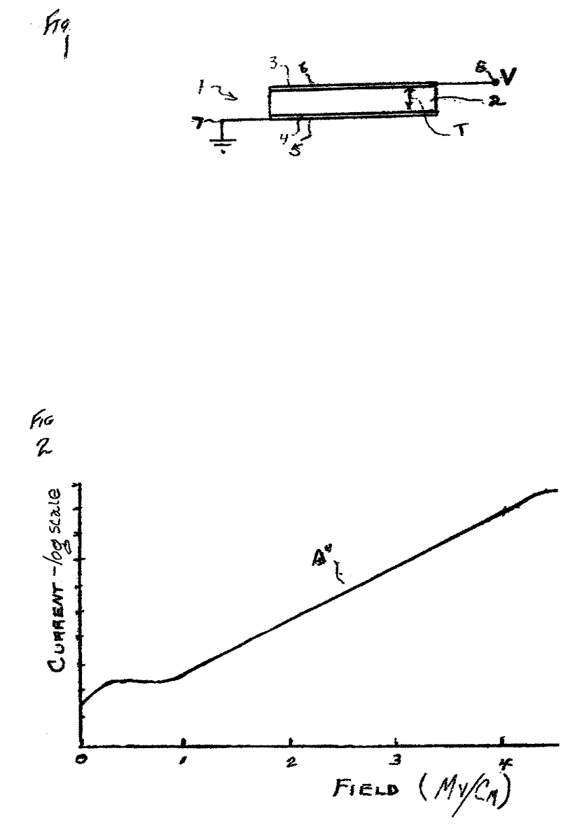

The over voltage protection element of the invention is illustrated in connection with FIG. 1 wherein in a schematic cross sectional view the element labelled 1 has a body 2 that exhibits a current vs field performance characteristic as illustrated in connection with FIG. 2 and does not become conductive after over voltage shunting.

Referring to FIGS. 1 and 2, the body 2 of the element 1 is of a nondestructive, over voltage passing, dielectric material amorphous alloy that exhibits impedance to current flow as a field across the element increases, passing current unimpeded at and above a selectable field region in the vicinity of the 2 Mv/cm example, that is correlated with the thickness of the body 2 and does not become permanently conductive after the unimpeded current passing.

The unique current vs field performance characteristic and properties required by the invention are satisfied where the material of the body 2 has essentially parallel surfaces separated by a selectable thickness dimension labelled “T”, and with a low resistivity metal or ohmic contact layer over all of each surface labelled 3 and 4 with the metal layers being 5 and 6. One layer, labelled 5, is connected directly to ground or reference at 7 and the remaining layer, labelled 6, is connected directly to a node labelled 8 of the circuitry arrangement where the control over spikes and surges superimposed on the voltage labelled V occur.

The material of the element 2 is a dielectric deposited as an amorphous alloy. Satisfactory materials in the art may be selected from a group comprising amorphous hydrogenated silicon carbide (SiCH), carbon doped oxides, SiCOH, amorphous hydrogenated carbon, diamond like carbon (DLC), and florinated diamond like carbon (FDLC). The amorphous alloy is deposited to a selectable thickness in a range of about 20 to 250 nanometers. In a typical integrated circuit member the thickness would be about 50 nanometers. In the thickness range the amorphous dielectric alloy member; acts as an insulator at fields less than about 2 Mv/cm nondestructively shunts over voltage spikes and surges to reference or around at fields above and in the vicinity of 2 Mv/cm, and returns to normal insulator performance when the over voltage situation ends.

Of the amorphous alloy materials, the materials hydrogenated silicon carbide(SiCH) and the SiCOH have been used heretofore in the art for standard dielectric properties. One product, of hydrogenated silicon carbide (SiCH), is marketed by Applied Materials Inc. under the trade name “BLOK”. The material SiCOH, is marketed by such vendors as Applied Materials Inc. under the trade name “Black Diamond”, and by Novellus Inc. under the trade name “Coral”.

In the unique current vs field performance characteristic illustrated in FIG. 2, the current increases logarithmically by a few orders of magnitude through a range labelled “A” of about 1-3.5 Mv/cm of field for a typical integrated circuit member. The field is the voltage divided by the film thickness dimension. The thickness dimension “T” can vary in a range of from 20 to 250 nanometers with the dimension for a typical integrated circuit being about 50 nanometers.

The body 2 of the over voltage protection element may be considered to behave in the presence of a field impressed between surfaces 3 and 4 of FIG. 1 in a breakdown type manner similar to that of a Zener or avalanche diode but has the additional performance feature that the body 2 does not become conductive after the breakdown type current flow rate, but rather, it returns to the normal performance when the field has been removed.

The invention can be constructed in many structural arrangements. In another example structural arrangement, two parallel conductive lines in a film of the dielectric amorphous alloy separated by the dimension “T”may be employed. The arrangement is amenable to standard and damascene types of patterning, serpentine geometry and length selection for current carrying adjustment.

The principle of the invention permits in-situ over voltage protection to selected nodes throughout an integrated circuit as well as at the interface with external circuitry and throughout the external circuitry.

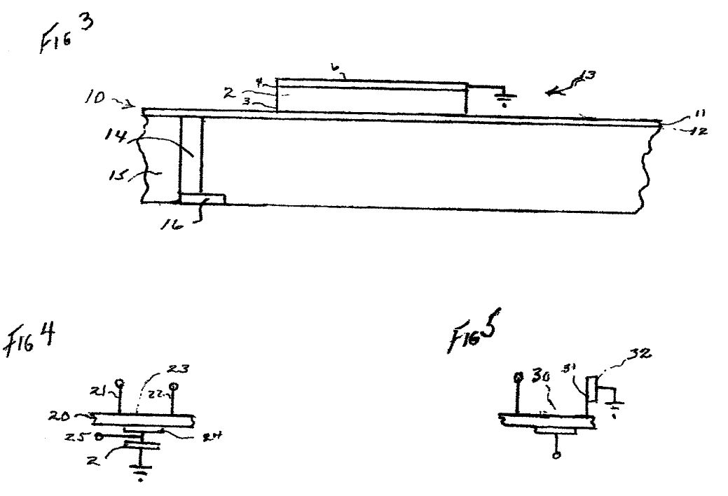

In FIG. 3 a depiction is provided of an interface between external wiring and an integrated circuit structure. In the art the external or system wiring has wider spacing tolerances and can be fabricated through a greater number of techniques whereas in contrast the intra chip wiring has tighter spacing tolerances and has fewer fabrication techniques available. The over voltage protection principle of the invention provides benefits in both external to and within the chip type situations. Referring to FIG. 3, the interface 10 between the external wiring and the chip wiring is illustrated by the voltage supply conductor 11 positioned on the surface 12 as an example of an interconnect wiring level. In accordance with the invention the over voltage control of an external circuitry condition such as a voltage spike or surge superimposed on the voltage supply conductor is provided by a discrete, or surrounded by dielectric 13, manifestation of the over voltage protection element 2 with metal contacts representing different circuitry wiring levels on faces 3 and 4 as in FIG. 1 where the face 3 is in contact with the supply conductor 11 and the face 4 is in contact with metal member 6 connected to ground. The thickness of the element 2 between the faces 3 and 4 is about 50 nanometers. In practice it may be beneficial to taper the sidewall of the over voltage control dielectric element 2 at member 11 to reduce points of high field. Other thicknesses for element 2 may be used within the invention.

The conductor 11 wiring level is connected through a via 14 through surrounding dielectric to the internal chip wiring level 16 to which the active devices not shown in this view are to be connected.

In FIGS. 4 and 5 the over voltage control of the invention is illustrated in connection with active devices such as bipolar and field effect transistors..

Referring to FIG. 4 a schematic depiction is provided of the over voltage protection element of the invention as applied to the control electrode of a device such as the gate of a field effect transistor. In FIG. 4 the field effect device body 20 has source 21 and drain 22 electrodes separated by a channel 23 the conductivity of which is influenced by a gate electrode 24. In accordance with the invention voltage spikes and surges appearing on the control conductor 25 are shunted to reference or ground while not affecting signals of a magnitude below breakdown on the conductor 25.

Referring to FIG. 5 the over voltage protection element of the invention is applied to an electrode of a device 30 such as the drain electrode 31 of a field effect transistor 32 or gate 25. In accordance with the invention voltage spikes and surges appearing on the electrode 31 or gate 25 are shunted to reference or ground while not affecting signals of a magnitude below breakdown.

What has been described is an over voltage spike or surge protection principle where an element is positioned between a node in the circuitry and a reference voltage that performs as an insulator as voltage across the element increases and at a selectable voltage, the current at any higher voltage such as during a spike or a surge is shunted to reference or ground, the element is not damaged by the breakdown type of the effect of the shunting of the current, and then, after the duration of the high voltage spike or surge the element returns to the performance before the selectable voltage.

What is claimed is:

1. In circuitry, protection from the effects of spike and surge over voltage occurrences, comprising:
an element positioned between a node in said circuitry and a reference voltage,
said element having a body of dielectric material with first and second essentially parallel faces separated by a thickness dimension and having conductive contact over each of said first and said second faces,
said body of dielectric material having a property that;
in the presence of an increasing field between said contacts over said first and said second faces, there is an increase in current flow at a first rate, and
in the presence of a field in the vicinity of 2 Mv/cm and above, there is a a nondestructive unlimited current flow second rate, and,
means connecting said conductive contact on said first face of said body to said node in said circuitry,and,
means connecting said conductive contact on said second face of said body to said reference voltage.

2. The over voltage protection of claim 1 wherein said body of dielectric material is an amorphous alloy member having a thickness in the sub 200 nanometer range.

3. The over voltage protection of claim 2 wherein the thickness of said body of dielectric material is about 50 nanometers.

4. The over voltage protection of claim 1 wherein said body of dielectric material is a deposited amorphous alloy taken from the group comprising amorphous hydrogenated silicon carbide (SiCH), carbon doped oxides, SiCOH, amorphous hydrogenated carbon, diamond like carbon (DLC), and florinated diamond like carbon (FDLC).

5 The method of providing over voltage protection in an integrated circuit, comprising the steps of:
positioning a body of dielectric material between a node in said integrated circuit and ground,
said body having first and second essentially parallel surfaces separated by a thickness dimension with a conductive contact over each of said first and said second surfaces,
said body, in the presence of an increasing field between said contacts over said first and said second faces, exhibiting an increase in current flow at a first rate, and in the presence of a field in the vicinity of 2 Mv/cm and above, exhibiting a nondestructive breakdown type unlimited current flow second rate, and,
connecting said conductive contact on said first face of said body to said node in said circuitry,and,
connecting said conductive contact on said second face of said body to said ground.

6. The method of claim 5 wherein said positioning of said body is by deposition to a thickness in the sub 200 nanometer range.

7. The method of claim 6 wherein said deposition is 50 nanometers thick.

8. The method of claim 5 wherein said deposition is of an amorphous alloy taken from the group comprising amorphous hydrogenated silicon carbide (SiCH), carbon doped oxides, SiCOH, amorphous hydrogenated carbon, diamond like carbon (DLC), and florinated diamond like carbon (FDLC).

9. An overvoltage protection member for use in circuitry in which over voltage spikes and surges may occur comprising in combination:
a body of dielectric material between a node in said integrated circuit and ground,
said body having first and second essentially parallel surfaces separated by a thickness dimension with a metal layer over each of said first and said second surfaces,
said body, in the presence of an increasing field between said contacts over said first and said second faces, passing increasing current at a first flow rate, and in the presence of a selected field, passing current at an unlimited second flow rate, and,
said metal layer on said first surface of said body being connected to said node in said circuitry, and,
said metal layer on said second surface of said body being connected to ground.

10. The protection member of claim 9 wherein said selected field is in the vicinity of 2 Mv/cm,

11. The protection member of claim 9 wherein said dielectric material is an amorphous alloy taken from the group comprising amorphous hydrogenated silicon carbide (SiCH), carbon doped oxides, SiCOH, amorphous hydrogenated carbon, diamond like carbon (DLC), and florinated diamond like carbon (FDLC).

12. The protection mender of claim 11 wherein said thickness dimension is 50 nanometers.

13. The protection member of claim 12 wherein said dielectric material is in deposited amorphous form

14. The method of fabricating an over voltage protection member in an integrated circuit member. comprising the steps of:
providing a layer of amorphous alloy material in said integrated circuit member,
said layer of amorphous alloy being of a thickness that permits voltage at the magnitude of said over voltage to be passed, and,
for each circuit node in said integrated circuit for which over voltage protection is desired,
providing on a first side of said amorphous alloy layer, a specific protection area contact connected to said circuit node, and,
providing high conductivity path means to reference potential, at the second and opposite side of said amorphous alloy layer at said circuit node location.

15. The method of claim 14 wherein in said step of providing an amorphous alloy layer the material of said layer is taken from the group comprising amorphous hydrogenated silicon carbide (SiCH), carbon doped oxides, SiCOH, amorphous hydrogenated carbon, diamond like carbon (DLC), and florinated diamond like carbon (FDLC).
